(19) United States
(12) Patent Application Publication
(10) Pub. No.: US 2015/0300650 A1
(43) Pub. Date: Oct. 22, 2015

(54) A COOKING HOB WITH ILLUMINATION EQUIPMENT

(71) Applicant: ELECTROLUX HOME PRODUCTS CORPORATION N.V., Brussels (BE)

(72) Inventors: Peter NEGRETTI, Forli (IT); Arran ALLSEBROOK, Porcia (IT); Frank BENOLD, Porcia (PN) (IT); Filippo ZANETTI, Forli (IT); Filippo TISSELLI, Forli (IT)

(21) Appl. No.: 14/648,447

(22) PCT Filed: Dec. 19, 2013
(86) PCT No.: PCT/EP2013/077279

§ 371 Date: May 29, 2015

(30) Foreign Application Priority Data
Jan. 8, 2013 (EP) 13150441.7

(51) Int. Cl. F24C 3/12; F24C 15/10; H05B 3/74

(52) U.S. Cl. CPC F24C 3/124; H05B 3/746; F24C 15/10

(57) ABSTRACT

A cooking hob with illumination equipment. The cooking hob includes a transparent or semi-transparent top panel arranged at a top side of the hob. The cooking hob includes at least one cooking zone and at least one control element for controlling the cooking zone. The cooking hob includes at least one transparent or semi-transparent layer. Symbols or images are printed on, applied on, impressed in and/or embossed in the layer. Each symbol or image corresponds with a cooking zone, a control element and/or an operation state of the cooking hob. The cooking hob includes light source elements arranged below the top panel and the layer. Each light source element corresponds with one or more symbols or images. One or more light source elements are activated on demand by the user and, if the corresponding cooking zone is activated, the corresponding control element responds or the corresponding operation state occurs, respectively.

The present invention relates to a cooking hob with illumination equipment. For example, the present invention relates to a gas cooking hob with illumination equipment.

On a panel of a cooking hob symbols are usually impressed with serigraphy, laser printing or similar techniques. For example, in order to adjust the flame level of a burner the user refers to flame symbols around the corresponding operating knob. The correlation between the burner and the related operating knob is illustrated by a printed symbol. Said symbol represents the burner and its position on the cooking hob.

However, such symbols are often not very comfortable. Moreover, the safety aspect is not always satisfactory.

It is an object of the present invention to provide an improved cooking hob, which overcomes the above problems.

The object of the present invention is achieved by the cooking hob according to claim 1.

The present invention relates to a cooking hob with illumination equipment, wherein:
the cooking hob includes at least one transparent or semi-transparent top panel arranged at a top side of said cooking hob,
the cooking hob includes at least one cooking zone and at least one control element for controlling said cooking zone,
the cooking hob includes at least one transparent or semi-transparent layer,
a plurality of symbols or images is printed on, applied on, impressed in and/or embossed in said layer,
the symbol or image corresponds with a cooking zone, a control element and/or an operation state of the cooking hob,
the cooking hob includes a plurality of light source elements arranged below the top panel and the layer,
the light source element corresponds with one or more symbols or images, and
one or more light source elements are activated on demand by the user and, if the corresponding cooking zone is activated, the corresponding control element is responsive or the corresponding operation state occurs, respectively.

The main aspect of the present invention is that the symbols are made visible just on demand. The symbols are completely invisible, when the related function is deactivated. The illuminated symbols improve the aesthetic of the design of the cooking hob. The illuminated symbols are even more visible when ambient light is poor. Moreover, the illuminated symbols at low background light are an aesthetic improvement.

Further, at least one of the symbols or images is elongated and extends along the bottom side of the top panel, wherein said elongated symbol connects the control element to the corresponding cooking zone. The elongated symbols indicate the correlation between the cooking zone and the corresponding control element.

Preferably, the transparent or semi-transparent layer is applied on a bottom side of the top panel. Alternatively, the layer may be applied at a top side of said top panel.

For example, the layer is made of a thin paint coating. In general, the layer may also be made of other materials with different thicknesses.

The cooking hob may include at least one on-off switch for activating and deactivating the cooking hob or a part of said cooking hob.

In particular, the cooking hob may include at least one light path extending between the control element and the related cooking zone. The light path indicates the correlation between the cooking zone and the corresponding control element.

Preferably, the light path is illuminated, when the cooking zone is activated by the control element.

Furthermore, the illumination intensity of the light path may be variable and may correlate with the power of the cooking zone.

For example, the light path includes at least one light guide. Said light guide may have coated surfaces in order to improve internal light reflections. The light guide may include optical fibres or side-glow optical fibres.

Moreover, the light path is illuminated by luminous sources arranged below the light path and/or along the light guide.

The light path and/or the light guide may include an elongated prism made of one or more transparent materials.

Further, the light path and/or the light guide may include coated surfaces in order to improve internal light reflections.

In particular, the cooking hob is a gas cooking hob including at least one gas burner.

Said gas cooking hob may include at least one spark plug inhibition device, which inhibits any spark plug operation, when the cooking hob is deactivated.

The gas cooking hob may further include at least one gas flow inhibition device, which inhibits any gas flow to the burner, when the cooking hob is deactivated.

Novel and inventive features of the present invention are set forth in the appended claims.

The present invention will be described in further detail with reference to the drawings, in which

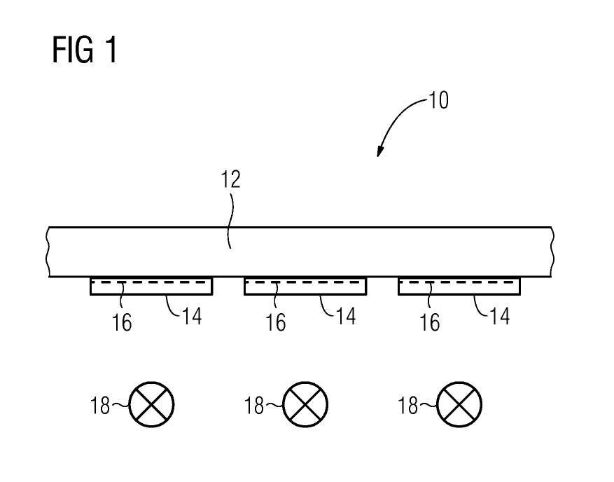

FIG. 1 illustrates a schematic partial sectional side view of a cooking hob with illumination equipment according to a preferred embodiment of the present invention.

FIG. 1 illustrates schematic partial sectional side view of a cooking hob 10 with illumination equipment according to a preferred embodiment of the present invention. The cooking hob 10 may be an electric or gas cooking hob.

The cooking hob 10 includes a top panel 12 arranged at its top side. Said top panel 12 is transparent or semi-transparent. For example, the top panel 12 is a glass ceramic panel. The cooking hob 10 includes one or more cooking zones and corresponding control elements for controlling said cooking zones.

Further, the cooking hob 10 includes a layer 14. In this example, the layer 14 is applied at a bottom side of the top panel 12. Alternatively, the layer 14 may be applied at a top side of said top panel 12. The layer 14 is made of a transparent or semi-transparent material. For example, the layer 14 is made of a thin paint coating. In general, the layer 14 may also be made of other materials with different thicknesses.

A number of symbols 16 or pictures is printed on and/or applied on the layer 14. Further, the symbols 16 may be impressed in and/or embossed in said layer 14. The symbol 16 corresponds with a cooking zone, a control element and/or an operation state of the cooking hob 10.

The symbols 16 may have a traditional design representing the power or flame level for example. The symbols 16 may further represent a knob-off position, a heater or burner association. In general, the symbol 16 may be an arbitrary images placed on the surface of the cooking hob 10.

The illuminated symbols 16 improve the aesthetic of the design. The illuminated symbols 16 are even more visible when ambient light is poor. Moreover, the illuminated symbols 16 at low background light are an aesthetic improvement.

Further, the cooking hob 10 includes a plurality of light source elements 18 arranged below the top panel 12 and the layer 14. The light source element 18 corresponds with one or more symbols 16. Alternatively, several light source elements 18 may correspond with one symbol 16.

The light source elements 18 are activated on demand by the user and, if the corresponding cooking zone is activated. Further, the light source elements 18 are activated on demand by the user and, if the corresponding control element is responsive. Moreover, the light source elements 18 are activated on demand by the user and, if the corresponding operation state occurs, respectively.

The light source elements 18 may be implemented with any kind of luminous source. For example, the light source elements 18 are lamps or light emitting diodes (LED).

All the symbols 16 or images are at least partially made of transparent or semi-transparent material. The light source elements 18 illuminate the transparent or semi-transparent areas on demand and then the symbols 16 are made visible.

The cooking hob 10 includes at least one on-off switch, which is not explicitly shown in FIG. 1. Said on-off switch is provided to activate the light source elements 18 in order to illuminate the symbols 16. Thus, the symbols 16 are illuminated just on demand by the user. When the light source elements 18 are deactivated, then the symbols 16 remain invisible. The on-off switch may be a button, a touch control, a proximity sensor, a sensor for a vocal command or a sensor for an RF signal. Further, the on-off switch may be activated and deactivated by a signal received from a serial port or an Ethernet port. When the on-off switch is activated, then the symbols 16 are visible. In contrast, when the on-off switch is deactivated, then the symbols 16 are not visible.

The on-off switch may be also provided for activating and deactivating the cooking hob 10 or a part of the cooking hob 10. In the latter case, only those light source elements 18 with said part of the cooking hob 10 are activated.

An additional feature of the present invention is a light path connecting the knob and the related burner or cooking zone, respectively. The light path from the knob to the burner or cooking zone is illuminated, when the user activates the burner or cooking zone by the knob. The light path is turned off, when the corresponding knob is in the power-off position or when the cooking hob is deactivated by the on-off switch.

Preferably, the light path is made of one or more transparent or semi-transparent materials. The light path may be illuminated by any kind of light sources, like lamps or light emitting diodes. The light path may be illuminated by a light guide. The illumination intensity of the light path may correlate with the power level of the burner or cooking zone. The light path may have arbitrary shapes and colours.

The association between knobs and burners or heating zones is clear and immediate thanks to the light paths. The light paths improve the awareness of the burners and cooking zones in use and consequently the safety. Furthermore, the light intensity modulation allows the user to have a feed-back of the power level of the burner and cooking zone. In particular, this is useful in gas cooking hobs, so that it is not necessary to check the flame level of the burner under the cookware.

The symbols 16 may have arbitrary shapes and can be placed anywhere on the top panel 12 of the cooking hob 10. For example, the symbols can be traditional symbols beside and/or around the knob. The symbols 16 may represent low and high power or flame, a knob-off position or the burner association.

Activating the on-off switch, the symbols 16 beside or around the knob are made visible. Deactivating the on-off switch, the knob symbols are not visible.

Preferably, the light path connecting the knob to the related burner or cooking zone is subordinated to the operations of the on-off witch. The light path from the knob to the burner or cooking zone is illuminated when the knob is activated or the flame of the burner or the cooking zone, respectively, is turned on. The light path can be illuminated by a light-guide or by a holder for multiple light sources.

The light and/or the light guide may be a prism made of glass or of any other transparent material having a temperature resistance up to 250° C. Further, the light guide may have coated surfaces in order to improve internal light reflections. Moreover, the light guide may include optical fibres or side-glow optical fibres.

The light path area on the cooking hob is made by one or more transparent or semi-transparent materials. The light path is illuminated by any kind of luminous sources as lamps or light emitting diodes. Said luminous sources are placed alongside of the light guide or underneath the light path area. The light path may be of arbitrary shapes and colours.

A modulation of the illumination intensity of the light path may be provided in order to give a visual indication on the flame level or heating intensity, respectively. The light path illumination is modulated according to the flame or temperature set by the related control knob or according to the actual power or flame level.

The gas cooking hob may comprise a device that inhibits spark plug operation, when the on-off switch is off. Said device may be implemented with a voltage-free contact of a relay operated by the no-off switch in order to cut the voltage supplied to a spark plug circuit.

Further, the gas cooking hob may comprise a device that inhibits gas flow to the burner when the on-off switch is deactivated. Said device may be implemented with a solenoid valve operated by the on-off switch in order to inhibit the gas flow from a main inlet to the burner, even if a tap is operated by the user.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 cooking hob
12 top panel
14 layer
16 symbol
18 light source element

1. A cooking hob with illumination equipment, wherein:
the cooking hob (10) includes at least one transparent or semi-transparent top panel (12) arranged at a top side of said cooking hob (10),
the cooking hob (10) includes at least one cooking zone and at least one control element for controlling said cooking zone,
the cooking hob (10) includes at least one transparent or semi-transparent layer (14),
a plurality of symbols (16) or images is printed on, applied on, impressed in and/or embossed in said layer (14),
the symbol (16) or image corresponds with a cooking zone, a control element and/or an operation state of the cooking hob (10),
the cooking hob (10) includes a plurality of light source elements (18) arranged below the top panel (12) and the layer (14),
the light source element (18) corresponds with one or more symbols (16) or images, and
one or more light source elements (18) are activated on demand by the user and, if the corresponding cooking zone is activated, the corresponding control element is responsive or the corresponding operation state occurs, respectively.

2. The cooking hob according to claim 1,
characterized in, that
at least one of the symbols (16) or images is elongated and extends along the bottom side of the top panel (12), wherein said elongated symbol (16) connects the control element to the corresponding cooking zone.

3. The cooking hob according to claim 2,
characterized in that
the transparent or semi-transparent layer (14) is applied on a bottom side of the top panel (12).

4. The cooking hob according to claim 1,
characterized in that
the layer is made of a thin paint coating.

5. The cooking hob according to claim 1,
characterized in that
the cooking hob (10) includes at least one on-off switch for activating and deactivating the cooking hob (10) or a part of said cooking hob (10).

6. The cooking hob according to claim 1,
characterized in that
the cooking hob (10) includes at least one light path extending between the control element and the related cooking zone.

7. The cooking hob according to claim 6,
characterized in that
the light path is illuminated, when the cooking zone is activated by the control element.

8. The cooking hob according to claim 6,
characterized in that
the illumination intensity of the light path is variable and correlates with the power of the cooking zone.

9. The cooking hob according to claim 6,
characterized in that
the light path includes at least one light guide.

10. The cooking hob according to claim 6,
characterized in that
the light path is illuminated by luminous sources arranged below the light path and/or along the light guide.

11. The cooking hob according to claim 6,
characterized in that
the light path includes an elongated prism made of one or more transparent materials.

12. The cooking hob according to claim 6,
characterized in that
the light path and/or the light guide include coated surfaces in order to improve internal light reflections.

13. The cooking hob according to claim 1,
characterized in that
the cooking hob (10) is a gas cooking hob including at least one gas burner.

14. The cooking hob according to claim 13,
characterized in that
the cooking hob (10) includes at least one spark plug inhibition device, which inhibits any spark plug operation, when the cooking hob (10) is deactivated.

15. The cooking hob according to claim 13,
characterized in that
the cooking hob (10) includes at least one gas flow inhibition device, which inhibits any gas flow to the burner, when the cooking hob (10) is deactivated.
